(19) United States
(12) Patent Application Publication
(10) Pub. No.: US 2021/0263889 A1
(43) Pub. Date: Aug. 26, 2021

(54) METHOD FOR IDENTIFYING INFORMATION IN FIELDS WITHIN A DOCUMENT THAT ARE ANOMALIES

(71) Applicant: MOTOROLA SOLUTIONS, INC., Chicago, IL (US)

(72) Inventors: ANOOP SEHGAL PARAS RAM, IPOH (MY); CHONG KEAT CHUA, AYER ITAM (MY); CHUN MENG TAN, BAYAN LEPAS (MY); KIM KOON NEOH, BAYAN LEPAS (MY)

(21) Appl. No.: 16/799,883

(22) Filed: Feb. 25, 2020

(51) Int. Cl. G06F 16/14; G06F 40/186; G06K 9/00; G06Q 50/26

(52) U.S. Cl. CPC G06F 16/156; G06Q 50/265; G06K 9/00483; G06F 40/186

(57) ABSTRACT

A method and apparatus for notifying authors of a statistical anomaly in paperwork is described herein. During operation information within fields of the paperwork will be identified that statistically differ from information contained in other paperwork from the same incident and/or other paperwork from similar incidents.

### BACKGROUND OF THE INVENTION

As part of a first responder's duties, various paperwork such as documents, reports, citations, and forms need to be filled out by first responders during and after certain incidents. Most often, this paperwork is filled out by an officer on an electronic device. The creation of such electronic paperwork related to an incident often leads to officers having to remember critical information about the incident. It would be beneficial for an officer if information on a current incident and similar past incidents can be leveraged so that more-accurate paperwork of the incident can be created.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 illustrates paperwork server.

FIG. 2 illustrates a form having fields.

FIG. 3 depicts an example communication system that incorporates paperwork server.

FIG. 4 is a block diagram of paperwork server.

FIG. 5 is a flow chart showing operation of the server of FIG. 3.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above-mentioned need, a method and apparatus for notifying authors of an anomaly in paperwork is described herein. During operation, information within fields of the paperwork will be identified that statistically differ from information contained in other paperwork from the same incident and/or other paperwork from similar incidents.

Expanding on the above, when multiple officers are assigned to an incident scene, the officers are often required to create paperwork describing what took place at the incident. Written paperwork about the incident are compared to determine information for any field that are statistical outliers when compared to the other paperwork describing the incident. All information within fields that are statistical outliers (anomalies) will be identified (e.g., highlighted) to the author. The paperwork about the incident that are used in determining statistical outlier of field values may comprise paperwork from past similar incidents, may comprise paperwork from the same incident, or may comprise paperwork from past similar incidents and paperwork from the same incident.

Consider the following example: An officer on normal car patrol stops a driver going 40 mph over the posted speed limit. In writing the driver a citation, the officer mistakenly identifies the car as going only 4 mph over the posted speed limit. If the server determines that 4 mph is an anomaly when compared to similar fields in past citations of similar incidents (i.e., past citations for speeding), the server will cause the field containing “4 mph” to be identified to the Officer.

In one embodiment of the present invention, the field is identified by highlighting the field in a particular color (e.g., red). However, other techniques for identifying the field may be used in various other embodiments. For example, anomalous field may be circled, presented with a particular colored text, presented with a particular font, italicized, bolded, . . . , etc.

In general police operations, a computer-aided dispatch (CAD) incident identifier (ID) is utilized to determine an incident assigned to an officer. This ID could be something as simple as a number, or something as complicated as an identification that is a function of populated fields, one of which may comprise an incident type. Thus, all officers that were assigned a similar or same CAD_ID may have their respective paperwork about the incident analyzed to determine if any statistical anomalies exist within the forms of the various paperwork. In addition to this, past paperwork having a CAD_ID for incidents that are similar will be used to determine if any statistical anomalies exist within the forms of the various paperwork.

As an example of the above, assume Officer Smith, Jones, Johnson, and Lee are all pursuing a suspect in a nighttime home invasion an automobile chase. In filling out paperwork describing the incident, Officers Smith, Jones, and Johnson state that the suspect wore a black shirt, however, Officer Lee stated that the suspect wore a yellow shirt. Since Officer Lee's description of the dress of the suspect is an anomaly when compared to Officers Smith, Jones, and Johnson's paperwork, this field of Officer Lee's report may be identified to him.

Notwithstanding the above, Officer Lee's report may be compared to other reports of home invasions from the past to determine if any value in any field is a statistical outlier (anomaly). For example, if statistically, home invaders wear dark clothing, then wearing a yellow shirt may be tagged as an anomaly when compared to past home invasions.

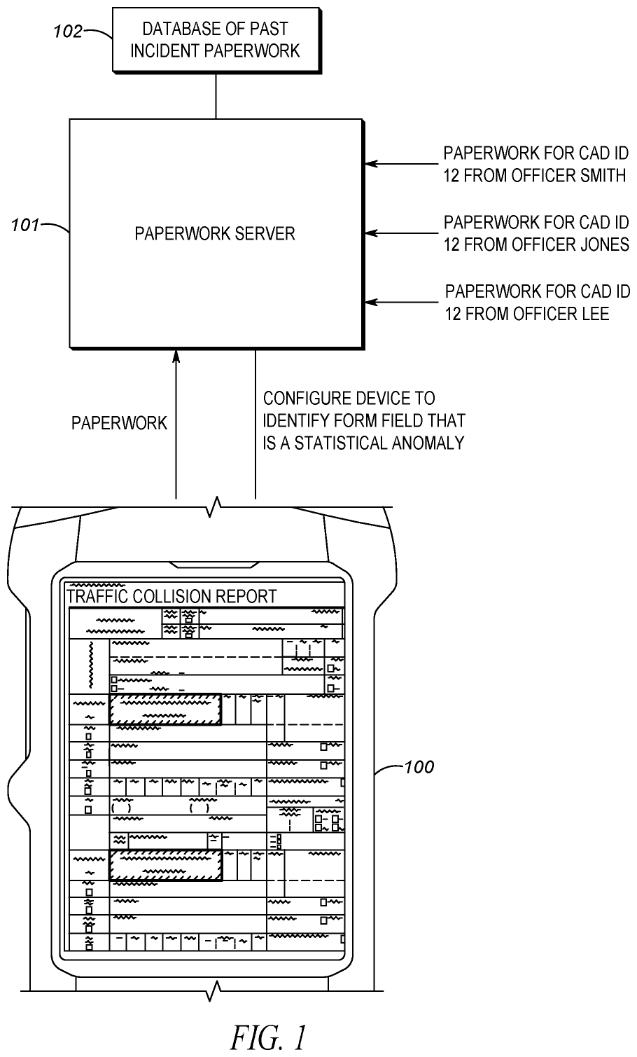

In order to accomplish the above, paperwork server 101 is provided (shown in FIG. 1). Paperwork server 101 is operable to receive paperwork from computer 100 and then analyze paperwork against paperwork for a same incident, and/or paperwork from past similar incidents (both identified via a CAD_ID), and determine if anomalous information exists within particular fields of the paperwork when compared to paperwork for the same incident and/or paperwork for past similar incidents. (It should be noted that term incident is meant to encompass public safety incidents such as crimes, offences, investigations, . . . , etc.).

During operation, paperwork for various incidents (identified by CAD_ID, in this case CAD_ID 12) enter server 101. Server 101 stores the paperwork in database 102. Paperwork server 101 then determines if any anomalies exist for values in form fields within any submitted paperwork (e.g., paperwork submitted by computer 100), and if so, configures computer 100 to identify the field that is a statistical anomaly.

It should be noted that computer 100 may comprise any electronic device capable of sending electronic paperwork to server 101 and receiving an instruction to identify a particular field of the electronic paperwork. Such electronic devices include, but are not limited to a tablet computer, a laptop computer, a wireless radio, a police radio, . . . , etc.

In one embodiment of the present invention, paperwork server 101 determines an anomalous entry by determining if the entry is statistically different than the information contained within similar fields from forms describing a similar event. In another embodiment, paperwork server 101 determines if an anomalous entry exists in a form field by comparing multiple fields from each form for various similar incidents. For example, it may be statistically significant that a male weighs 110 lbs. This would be determined by server 101 comparing multiple fields of a form (gender, weight, age, . . . , etc.) to determine if a weight input into a form is a statistical anomaly.

In another embodiment, paperwork server 101 determines if an anomalous entry exists in a form field by comparing form fields from each form for similar incidents. For example, a particular location at a particular highway had set a speed limit of 60 mph. A police officer had issued an electronic citation to a driver with a typo that stated the driver had sped at 30 mph. It will be statistically significant that the speed of 30 mph typed on the electronic citation is anomaly to other electronic citations issued prior in this area. This would be determined by server 101 comparing similar fields of a form (incident type, incident location . . . , etc.) to determine if an input into a form is a statistical anomaly.

In another embodiment, paperwork server 101 determines if an anomalous entry exists in a form field by comparing a keyword mentioned in one or multiple fields from each form for various similar incidents. For example, if a particular company or organization is being investigated under Commercial Corruption act. The chair or CEO of the organization has to detail out a particular amount of money usage, says on 1 Jan. 2020 an amount of 1 million USD was banked in to a suspicious account number. One of the investigators had keyed in one of the details wrongly (being such as, the date or the banked in account number or etc.). This would be determined by server 101 comparing the keyword mentioned in a form (such as the CEO's name or the organization's name . . . , etc.) to determine if an input into a form is a statistical anomaly.

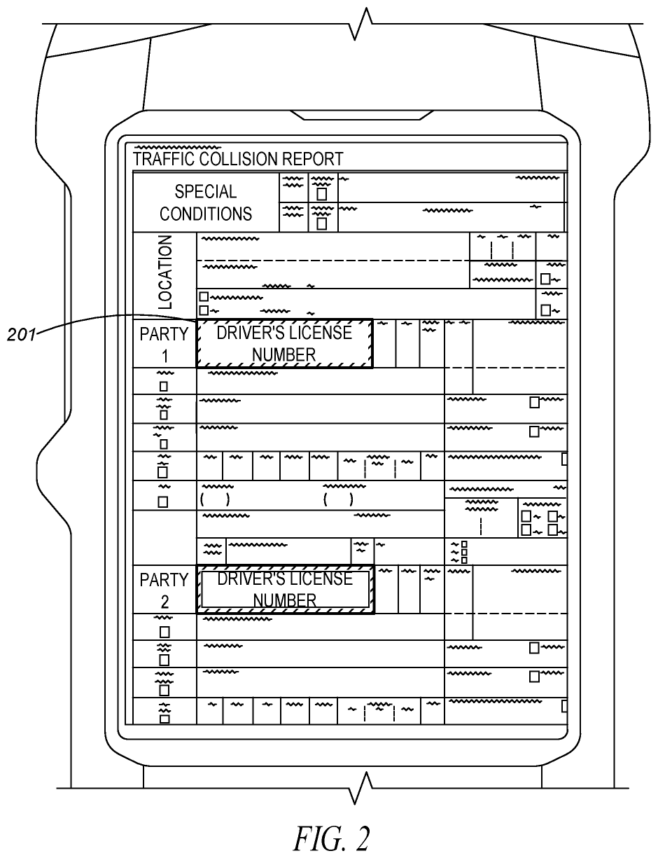

As shown in FIG. 2, officers are presented forms to fill out for particular incidents on electronic devices. These forms comprise fields 201 (only one field labelled in FIG. 2). One field might comprise a CAD_ID field, while other fields comprise information that is relevant to a particular incident. Server 101 will compare forms associated with the same CAD_ID and/or forms associated with past similar incidents by comparing each field of the multiple paperwork to determine if a statistical anomaly exists for a particular field. As described above, several fields from each form may be analyzed to determine if information within a particular field is anomalous.

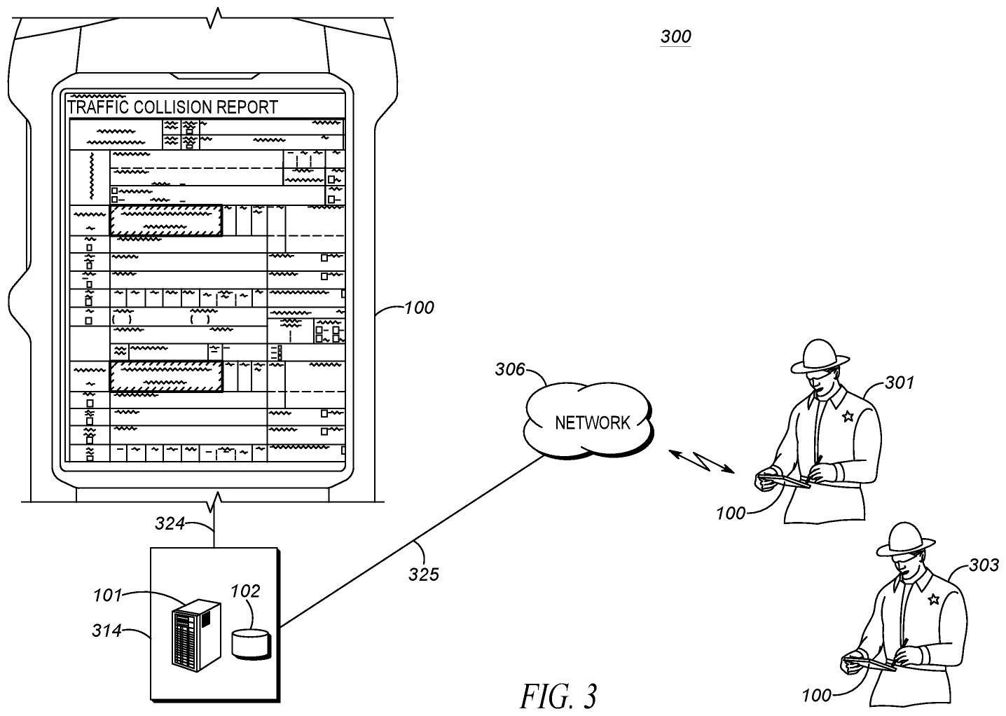

FIG. 3 illustrates a general operating environment for the present invention. Environment 300 includes one or more networks 306 (only one shown in FIG. 3), which may comprise a high-speed wireless network, or a radio-access network having a public-safety core network. Environment 300 also includes dispatch center 314, and communication links 325 and 324. In a preferred embodiment of the present invention, dispatch center 314 serves as a public-safety dispatch center 314. Server 101 receives paperwork over the air or from a wired connection from computers 100 operated by officers 301-303 and stores the paperwork in database 102.

Network 306 comprises a network such as, but not limited to, a high-speed data network 306 such as a cellular communication system and/or public-safety core network and radio-access network (RAN). Thus, network 306 may comprise a combination of a public-safety core network 306 and/or a high-speed data network 306 (e.g., Verizon, Spring, AT&T, . . . , etc.) for carrying high-speed data. Each of these networks may be utilized for transmitting electronic paperwork.

Devices 100 may be any suitable computing and/or communication devices operable to transmit electronic paperwork over an air interface or a wired interface as is known to those in the relevant art. It should be noted that while only two officers 301-303 are shown in FIG. 3, one of ordinary skill in the art will recognize that hundreds of officers and devices 100 may actually exist in environment 300.

During operation, officers 301-303 are assigned to a particular incident. As part of the assignment, officers 301-303 are tasked to write paperwork about the incident. The paperwork may be written at the incident utilizing devices 100, or may be written after the incident has been disposed of, at for example, a desktop or laptop computer. Regardless of how or where the paperwork is generated, the paperwork is then submitted to paperwork server 101 through network 306 or via computers existing, or connected to dispatch center 314, or a police station, and submitted directly to server 101. All paperwork is stored in database 102.

Server 101 analyzes the paperwork stored in database 102. For each incident (identified by CAD_ID), the paperwork is compared, and it is determined if a statistical anomalies exist between any field of the forms. Alternatively, forms for past incidents may be analyzed to determine if a statistical anomaly exists between any form field and past incidents. Alternatively, forms from both past and the current incident may be used to determine if any field of a form has a statistical anomaly.

The determination of whether information in a field of a form is a statistical anomaly may take place by determining a statistical distribution (e.g., Binomial distribution, degenerate distribution, Conway-Maxwell-Poisson distribution, Poisson distribution, Skellam distribution, Beta distribution, . . . , etc.) for the information within the field among forms from the particular incident and/or forms from similar incidents. A probability of the particular information in any field of the form occurring may be determined, and if the probability is below a predetermined threshold, the form field may be identified (e.g., highlighted). For example, if a information within a field in a form has less than a 5% chance of occurring, then the field of the form may be identified.

As discussed above, multiple fields of forms may be utilized to determine if a value for a field is a statistical anomaly (e.g., the value has less than a predetermined chance of happening, e.g., happens less than 5% of the time). For example, if a male subject's weight is less than 110 lbs, this may be flagged as a statistical anomaly.

The determination of whether or not a value in a form is an anomaly may be performed by a machine learning algorithm. As more data is collected the machine learning algorithm could provide anomalies ranges for each field of a particular form.

When a statistical anomaly is detected for information in a form field by server 101, server 101 causes the form field to be identified by, for example, highlighting the field. This may be done by sending an explicit command to a device 100 to highlight the field.

As is evident, server 101 maps whether or not to identify (e.g., highlight) a field of a form based on whether or not statistically significant differences exist for the information within the form with the information of the field from similar paperwork. The mapping process preferably comprises an operation that associates each element of a given set (the domain) with one or more elements of a second set (the range). Whether or not statistically significant differences exist within the paperwork comprises the domain, while whether or not to identify the form field comprises the range. The mapping is explicit based on predefined rules, for example, if the value in a form field has less than a 5% chance of occurring.

Server 101 maps whether or not the information within a field in paperwork is statistically different to whether or not the field should be identified (e.g., highlighted). More specifically, if whether or not an anomaly for information within field exists (x) is an element of a group X (i.e., “an anomaly exists” or “no anomaly exists”), we say that f “takes the value” or “maps to” f(x) at x. The set X is called the domain of the function f. The set of possible outcomes of f(x) is called the range. In this case, the range comprises whether or not to identify the field of the paperwork, so f(x) comprises either “identify the field” or “do not identify the field”.

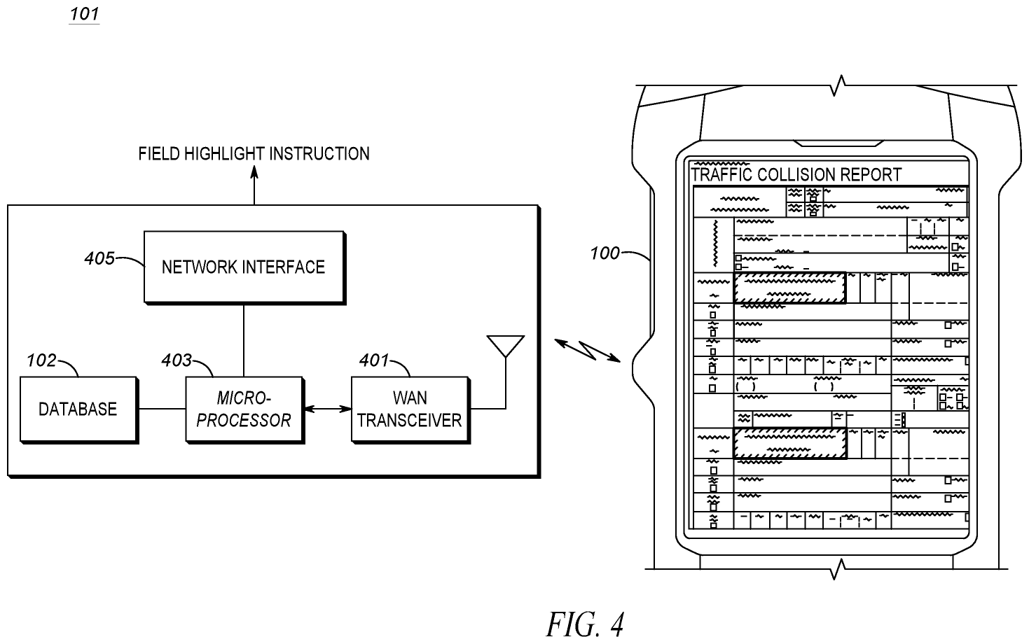

FIG. 4 is a block diagram of server 101. In an embodiment, server 101 is embodied within a dispatch center, however in alternate embodiments the device may be embodied within the public-safety core network, or more computing devices in a cloud compute cluster (not shown), or some other communication device not illustrated in FIG. 3, and/or may be a distributed communication device across two or more entities.

FIG. 4 shows those components (not all necessary) of server 101. As shown, server 101 may include a wide-area-network (WAN) transceiver 401 (e.g., a transceiver that utilizes a public-safety communication-system protocol), logic circuitry 403, database 102, and network interface 405. In other implementations, server 101 may include more, fewer, or different components. Regardless, all components are connected via common data busses as known in the art.

WAN transceiver 401 may comprise well known long-range transceivers that utilize any number of network system protocols. (As one of ordinary skill in the art will recognize, a transceiver comprises both a transmitter and a receiver for transmitting and receiving data). For example, WAN transceiver 401 may be operable to utilize a next-generation cellular communications protocol operated by a cellular service provider, or any public-safety protocol such as an APCO 25 network or the FirstNet broadband network. WAN transceiver 401 receives a form from various devices 100, and transmits to the devices, an instruction to identify a particular field of the form. It should be noted that WAN transceiver 401 is shown as part of server 101, however, WAN transceiver 401 may be located in a RAN, with a direct link to server 101.

Logic circuitry 403 comprises a digital signal processor (DSP), general purpose microprocessor, a programmable logic device, or application specific integrated circuit (ASIC) and is operable to identify statistical anomalies for information within fields within paperwork, and identify the form field as described herein.

Database 102 is provided. Database 102 comprises standard memory (such as RAM, ROM, . . . , etc) and serves to store paperwork on incidents submitted by officers.

Finally, network interface 405 provides processing, modulating, and transceiver elements that are operable in accordance with any one or more standard or proprietary wireless interfaces, wherein some of the functionality of the processing, modulating, and transceiver elements may be performed by means of the logic circuitry 403 through programmed logic such as software. Examples of network interfaces (wired or wireless) include Ethernet, T1, USB interfaces, IEEE 802.11b, IEEE 802.11g, etc.

With the above in mind, FIG. 4 provides for an apparatus comprising a database configured to store paperwork describing public-safety incidents. Logic circuitry is provided to receive new paperwork describing a first public-safety incident, and access the database to determine stored similar paperwork. The stored similar paperwork comprises information about multiple public-safety events similar to the first public-safety event. The logic circuitry then compares the information within form fields in the new paperwork to the information within form fields of the similar paperwork in order to determine anomalies in any information within form fields in the new paperwork. The logic circuitry can then output an instruction to identify any field of the new paperwork that has anomalous information.

As discussed above, the paperwork describing public-safety incidents stored in the database may comprise paperwork describing past public-safety incidents, and the instruction to identify comprises an instruction to highlight, bold, italicize, circle, use a particular colored text, use a particular font, or bold text. Additionally, the logic circuitry may determine anomalies by determining a distribution of form fields in the stored similar paperwork, and determining anomalies by determining the information within a particular form field in the new paperwork is a statistical outlier when compared to the distribution. The distribution may comprise a Normal distribution, a Bernoulli distribution, a Beta-Binomial distribution, a Degenerate distribution, Binomial distribution, degenerate distribution, a Conway-Maxwell-Poisson distribution, a Poisson distribution, a Skellam distribution, or a Beta distribution

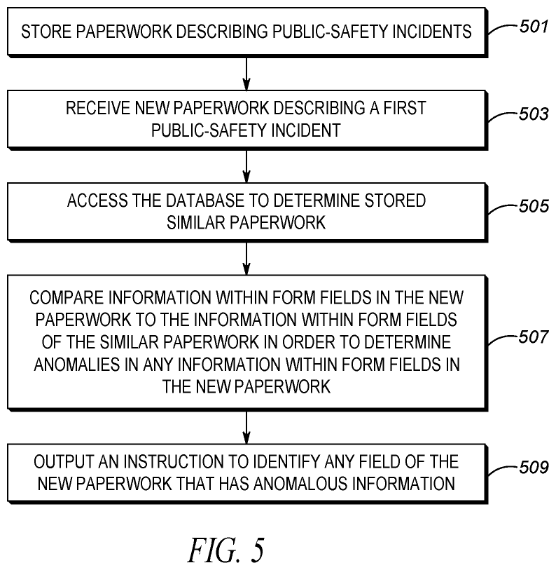

FIG. 5 is a flow chart showing operation of the server of FIG. 4. The logic flow begins at step 501 where database 102 stores paperwork describing public-safety incidents. At step 503, logic circuitry 403 receives new paperwork describing a first public-safety incident. This paperwork may be received from network interface 405 or WAN transceiver 401. Logic circuitry 403 then accesses the database to determine stored similar paperwork, wherein the stored similar paperwork comprises information about multiple public-safety events similar to the first public-safety event (step 505). At step 507, logic circuitry 403 then compares information within form fields in the new paperwork to the information within form fields of the similar paperwork in order to determine anomalies in any information within form fields in the new paperwork. Finally, at step 509 logic circuitry 403 outputs an instruction to identify any field of the new paperwork that has anomalous information. This instruction is output to network interface 405 or WAN transceiver 401 to be forwarded to device 100.

As discussed, the paperwork describing public-safety incidents stored in the database comprise paperwork describing past public-safety incidents. Additionally, the instruction to identify comprises an instruction to highlight, bold, italicize, circle, use a particular colored text, use a particular font, or bold text.

Finally, the anomalies are determined by determining a distribution of form fields in the stored similar paperwork, and determining anomalies by determining the information within a particular form field in the new paperwork is a statistical outlier when compared to the distribution.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending in the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through an intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An apparatus comprising:
a database configured to store paperwork describing public-safety incidents;
logic circuitry configured to:
receive new paperwork describing a first public-safety incident;
access the database to determine stored similar paperwork, wherein the stored similar paperwork comprises information about multiple public-safety events similar to the first public-safety incident;
compare information within form fields in the new paperwork to the information within form fields of the similar paperwork in order to determine anomalies in any information within form fields in the new paperwork; and
output an instruction to identify any field of the new paperwork that has anomalous information.

2. The apparatus of claim 1 wherein the paperwork describing public-safety incidents stored in the database comprise paperwork describing past public-safety incidents.

3. The apparatus of claim 1 wherein the instruction to identify comprises an instruction to highlight, bold, italicize, circle, use a particular colored text, use a particular font, or bold text.

4. The apparatus of claim 1 where the logic circuitry determines anomalies by determining a distribution of form fields in the stored similar paperwork, and determining anomalies by determining the information within a particular form field in the new paperwork is a statistical outlier when compared to the distribution.

5. The apparatus of claim 4 wherein the distribution comprises a Normal distribution, a Bernoulli distribution, a Beta-Binomial distribution, a Degenerate distribution, Binomial distribution, degenerate distribution, a Conway-Maxwell-Poisson distribution, a Poisson distribution, a Skellam distribution, or a Beta distribution.

6. An method comprising the steps of:
storing paperwork describing public-safety incidents within a database;
receiving new paperwork describing a first public-safety incident;
accessing the database to determine stored similar paperwork, wherein the stored similar paperwork comprises information about multiple public-safety events similar to the first public-safety event;
comparing information within form fields in the new paperwork to the information within form fields of the similar paperwork in order to determine anomalies in any information within form fields in the new paperwork; and
outputting an instruction to identify any field of the new paperwork that has anomalous information.

7. The method of claim 6 wherein the paperwork describing public-safety incidents stored in the database comprise paperwork describing past public-safety incidents.

8. The method of claim 6 wherein the instruction to identify comprises an instruction to highlight, bold, italicize, circle, use a particular colored text, use a particular font, or bold text.

9. The method of claim 6 where the anomalies are determined by determining a distribution of form fields in the stored similar paperwork, and determining anomalies by determining the information within a particular form field in the new paperwork is a statistical outlier when compared to the distribution.

10. The method of claim 9 wherein the distribution comprises a Normal distribution, a Bernoulli distribution, a Beta-Binomial distribution, a Degenerate distribution, Binomial distribution, degenerate distribution, a Conway-Maxwell-Poisson distribution, a Poisson distribution, a Skellam distribution, or a Beta distribution.

11. An method comprising the steps of:
storing paperwork describing past public-safety incidents;
receiving new paperwork describing a first public-safety incident;
accessing the database to determine stored similar paperwork, wherein the stored similar paperwork comprises information about multiple public-safety events similar to the first public-safety event;
comparing information within form fields in the new paperwork to the information within form fields of the similar paperwork in order to determine anomalies in any information within form fields in the new paperwork; and
outputting an instruction to identify any field of the new paperwork that has anomalous information, wherein the instruction to identify comprises an instruction to highlight, bold, italicize, circle, use a particular colored text, use a particular font, or bold text; and
wherein the anomalies are determined by determining a distribution of form fields in the stored similar paperwork, and determining anomalies by determining the information within a particular form field in the new paperwork is a statistical outlier when compared to the distribution.

12. The method of claim 11 wherein the distribution comprises a Normal distribution, a Bernoulli distribution, a Beta-Binomial distribution, a Degenerate distribution, Binomial distribution, degenerate distribution, a Conway-Maxwell-Poisson distribution, a Poisson distribution, a Skellam distribution, or a Beta distribution.
